(19) United States
(12) Patent Application Publication
(10) Pub. No.: US 2011/0153525 A1
(43) Pub. Date: Jun. 23, 2011

(54) METHOD AND SYSTEM FOR MANAGING POWER CONSUMPTION USING GEOLOCATION INFORMATION

(75) Inventors: David S. Benco, Winfield, IL (US); Patricica S. Beck, Glen Ellyn, IL (US)

(73) Assignee: Alcatel-Lucent USA Inc., Murray Hill, NJ (US)

(21) Appl. No.: 12/642,045

(22) Filed: Dec. 18, 2009

(51) Int. Cl. G06F 1/32; H04W 24/00; G08C 17/02; G06Q 30/00; G06Q 50/00; G05D 23/19

(52) U.S. Cl. 705/412; 455/456.1; 340/870.02; 700/297; 700/276

(57) ABSTRACT

A method of controlling power consumption comprising defining a boundary region surrounding a power-consuming structure and obtaining geolocations for one or more mobile terminals over a telecommunications network. The method also comprises determining whether or not the one or more mobile terminals are located inside or outside of said boundary region and changing a power mode of the power-consuming structure. The power mode is changed to a low-power consumption mode when the geolocations of each of the mobile terminals are outside of the boundary region. Or, the power mode is changed to a high-power consumption mode when the geolocation of at least one of the mobile terminals is inside the boundary region.

### TECHNICAL FIELD

The present disclosure is directed, in general, to power management methods and systems, and more specifically, managing power consumption using geolocation information.

### BACKGROUND

This section introduces aspects that may be helpful to facilitating a better understanding of the inventions. Accordingly, the statements of this section are to be read in this light. The statements of this section are not to be understood as admissions about what is in the prior art or what is not in the prior art.

There is interest in reducing power utilization (e.g., electricity, natural gas, heating oil etc. . . . ) in a variety of power-consuming structures ranging from commercial and residential buildings to individual appliances. Some methods, once programmed into a device, can be inflexible, however. For instance, thermostats are often programmed to activate and deactivate building heating and cooling equipment at fixed times and days of the week, and do so regardless of whether the building is actually occupied or not. This can lead to greater-than-desired power consumption by the heating and cooling equipment, or, uncomfortable living conditions for occupants in the building at times or days when the equipment is programmed to deactivate.

### SUMMARY

One embodiment is a method of controlling power consumption. The method comprises defining a boundary region surrounding a power-consuming structure and obtaining geolocations for one or more mobile terminals over a telecommunications network. The method also comprises determining whether or not the one or more mobile terminals are located inside or outside of the boundary region and changing a power mode of the power-consuming structure. The power mode is changed to a low-power consumption mode when the geolocation of each of the mobile terminals are outside of the boundary region. Or, the power mode is changed to a high-power consumption mode when the geolocation of at least one of the mobile terminals is inside the boundary region.

Another embodiment is a computer-readable medium, comprising computer-executable instructions that, when executed by a computer, perform the above-described method.

Another embodiment is a system for controlling power consumption. The system comprises a geolocation server and a power-adjusting device. The geolocation server is configured to store a virtual representation of a boundary region surrounding a power-consuming structure, receive geolocation information from one or more mobile terminals, and determine whether or not the one or more mobile terminals are located inside or outside of the boundary region. The power-adjusting device is in communication with the geolocation server, and, configured to change a power mode of the power-consuming structure. The power mode is changed to a low-power consumption mode when the geolocations of each of the mobile terminals are outside of the boundary region. Or, the power mode is changed to a high-power consumption mode when the geolocation of at least one of the mobile terminals is inside the boundary region.

### BRIEF DESCRIPTION OF THE DRAWINGS

The embodiments of the disclosure are best understood from the following detailed description, when read with the accompanying FIGUREs. Corresponding or like numbers or characters indicate corresponding or like structures. Various features may not be drawn to scale and may be arbitrarily increased or reduced in size for clarity of discussion. Reference is now made to the following descriptions taken in conjunction with the accompanying drawings, in which:

FIG. 1 presents a flow diagram of an example method of controlling power consumption in accordance with the disclosure;

FIG. 2 presents a block diagram showing selected components of an example system of the disclosure and further illustrate certain aspects of the example method presented in FIG. 1; and

FIG. 3 presents example power modes such as power modes of an embodiment of the example system of FIG. 2 and further illustrate certain aspects of the example method presented in FIG. 1.

### DETAILED DESCRIPTION

The description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof. Additionally, the term, “or,” as used herein, refers to a non-exclusive or, unless otherwise indicated. Also, the various embodiments described herein are not necessarily mutually exclusive, as some embodiments can be combined with one or more other embodiments to form new embodiments.

Embodiments of the disclosure improve the power management by using geolocation information to determine the presence or absence of users in a boundary region surrounding a power-consuming structure. The geographical location (i.e., “geolocation”) of each user is determined by estimating the location of a mobile terminal associated with each user. If all the mobile terminals are located outside of the boundary region, then power consumption can be reduced to a low-power mode. If at least one of the mobile terminals is located inside of the boundary region, then power consumption can be returned to, or maintained in, a high-power mode.

The term, power-consuming structure, as used herein refers to any man-made structure that uses power or includes a power consuming component, and whose power utilization can be adjusted, e.g., by turning the structure or its component on or off, or, reducing the amount of power delivered to the structure or its component. Non-limiting examples include residential homes, commercial office buildings or sections thereof (e.g., a floor or wing of the building), and their cooling or heating components (e.g., HVAC systems), or, appliances, such as indoor or outdoor lighting, ovens, dishwashers or coffeemakers, or medical devices such as an air filtration system, or office devices such as photocopy machines or computers.

The terms, low-power mode and high-power mode, as used herein refer to different relative states of power consumption that a power-consuming structure can have. For instance, in some embodiments, the low-power mode of a power-consuming structure (e.g., an oven or coffeemaker) can be an “off” power state, and the high-power mode can be a normal operating “on” power state. In other embodiments, the low-power mode can be an “intermediate” power state, where power consumption is between an “off” state and the normally operating “on” state. As an example, the low-power mode can be defined by higher or lower thermostat temperature set-points that result in reduced power consumption of a building's heating or cooling devices over the course of a day. As another example, the low-power mode can be defined by a reduced amount of power that is delivered to heating or cooling devices.

The term “mobile terminals” as used here refers to any device that transmits information that can used to determine a geolocation of the mobile terminal. Non-limiting examples of mobile terminals include the mobile GPS device in mobile telephone, in-vehicle security or navigation systems (e.g., ONSTAR™, LOJACK™), or other mobile location devices.

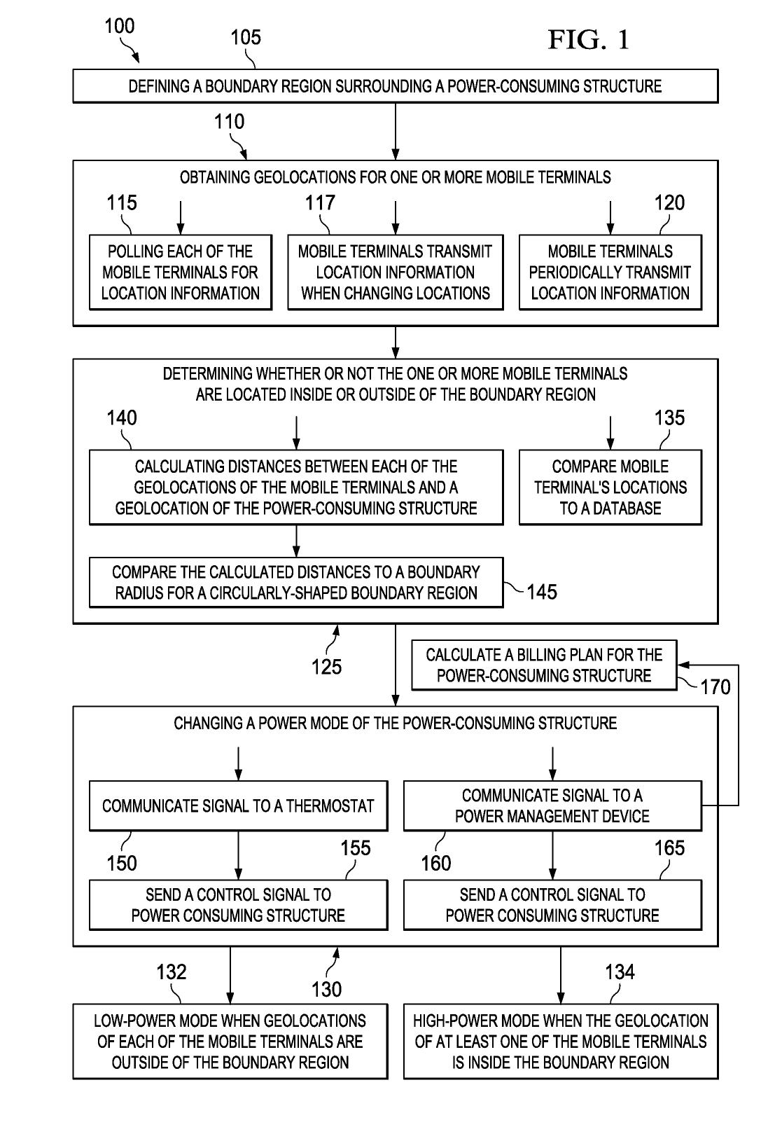

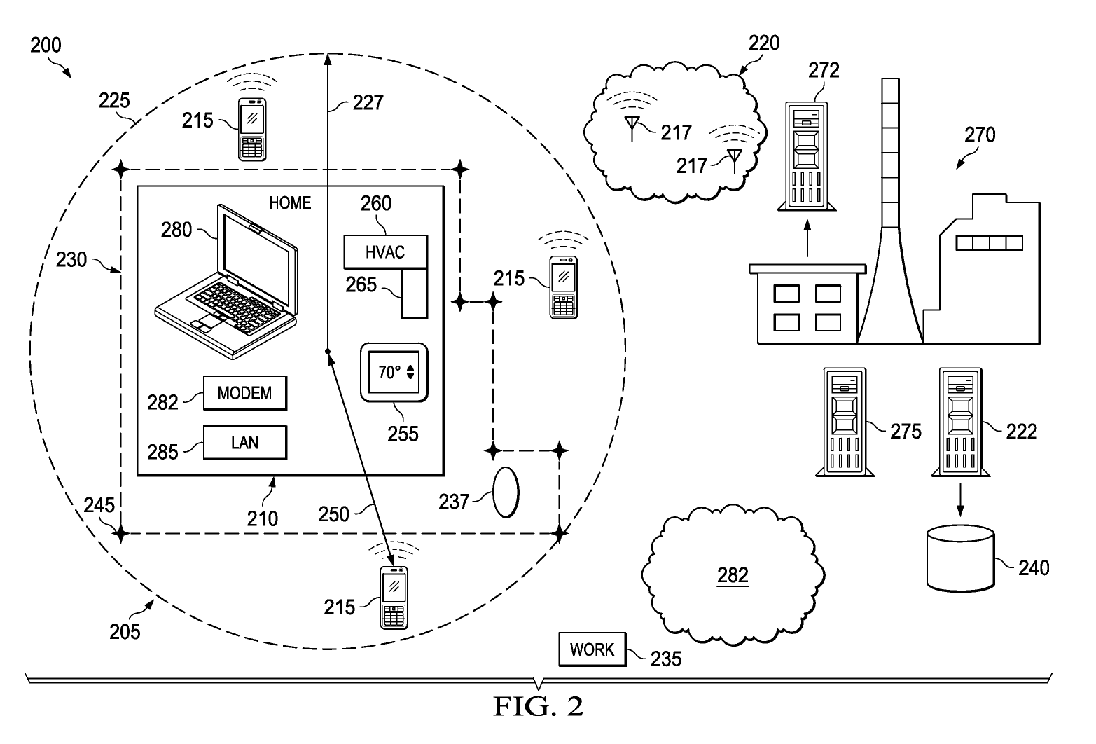

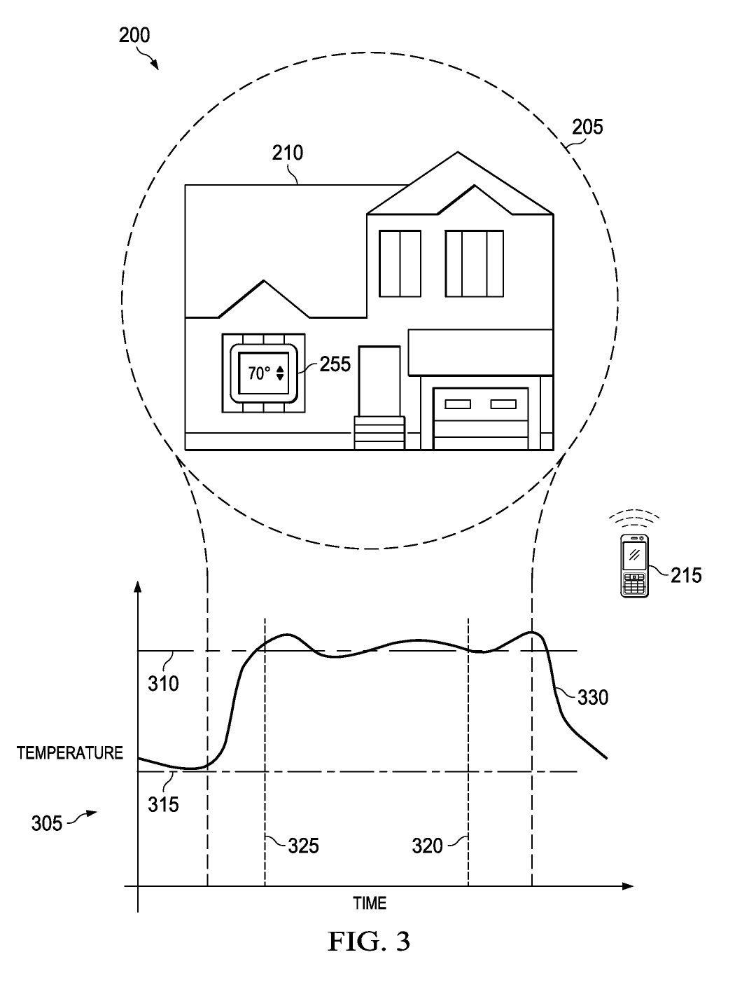

FIG. 1 presents a flow diagram of an example method 100 of controlling power consumption. FIG. 2 presents selected components of an example system 200 of the disclosure and illustrates certain aspects of the example method 100 presented in FIG. 1. FIG. 3 presents example power modes for an embodiment of the example system 200 and illustrates certain aspects of the example method 100 presented in FIG. 1.

The example method 100 comprises a step 105 (FIG. 1) of defining a boundary region 205 surrounding a power-consuming structure 210 (FIG. 2). The method 100 also comprises a step 110 (FIG. 1) of obtaining geolocations for one or more mobile terminals 215 (FIG. 2) over a telecommunications network 220 (FIG. 2). The method further comprises a step 125 of determining whether or not the one or more mobile terminals 215 are located inside or outside of the boundary region 205. The method 100 also comprises a step 130 (FIG. 1) of changing a power mode 305 (FIG. 3) of the power-consuming structure 210. A low-power consumption mode 310 (FIG. 3) is adopted in step 132 (FIG. 1) when the geolocations of each of the mobile terminals 215 are outside of the boundary region 205. A high-power consumption mode 315 (FIG. 3) is adopted in step 134 (FIG. 1) when the geolocation of at least one of the mobile terminals 215 is inside the boundary region 205.

With continuing reference to FIGS. 1-2, one skilled in the art would be familiar with various processes and means (e.g., computerized mapping and drawing software) to facilitate defining boundary regions (step 105), e.g., on a virtual map stored in a computer. In some embodiments, defining the boundary region 205 in step 105 can include defining a circularly-shaped boundary 225 of a defined radius 227 (FIG. 2) with the power-consuming structure 210 at the center of the circular boundary. Defining a circularly-shaped, or other regularly-shaped boundary 225 has the advantages of being computationally simple to implement in a virtual map and in having low memory requirements to store in a database that, e.g., may also hold defined boundary regions 205 for multiple power-consuming structures 110.

In some embodiments, defining the boundary region 205 in step 105 can include defining an irregular-shaped boundary 230 (FIG. 2). Defining an irregular-shaped boundary 230 has the advantages of being able to include or exclude particular geographical locations nearby the power-consuming structure 210 so as to improve power management, or, improve the use or enjoyment of the power-consuming structure 210. For instance, consider the case when the power-consuming structure 210 includes, or is, a residential home. The irregular-shaped boundary 230 can be defined so as to exclude a nearby location 235 (e.g., a work location), thereby allowing the low-power mode to be adopted (step 132) when the user (e.g., the occupant of the home) of the power-consuming structure 205 goes to the location 235 (e.g., goes to work). Additionally, or alternatively, the irregular-shaped boundary 230 can be defined so as to include a nearby location 237 (e.g., a convenience store, a neighbor's home, a jogging trail etc. . . . ) thereby preventing the low-power mode from being adopted when the user of the power-consuming structure 210 goes to the location 237. This, in turn, can facilitate maintaining the power-consuming structure 210 in a desired condition (e.g., the temperature is maintained at a comfortable level in a home 210) while the user briefly visits the nearby location 237.

With continuing reference to FIG. 2, in some embodiments, it is advantageous for the boundary region 205 to include a separate entry boundary region 225 and exit boundary region 230. In some cases, for instance, the exit boundary region 230 is smaller in area than the entry boundary region 225. For example as shown in FIG. 2 the irregular shaped exit region 230 can have a smaller area than the entry region 225. As another example a circularly shaped exit boundary region could have a smaller radius (not shown) than a radius 227 of a circularly shaped entry boundary region 225. It can be advantageous to have a smaller area exit boundary region 230 than entry boundary region 225 because this can facilitate the low-power mode 310 being adopted sooner after all of the mobile terminals 215 move from inside to outside of the exit boundary region 230, thereby improving power management. It can be advantageous to have a larger area entry boundary region 225 than an exit boundary region 230, because this can facilitate the high-power mode 315 being adopted for a sufficient period to have a desired effect on the power-consuming structure 210. For instance, having a larger entry boundary region 225 can allow a sufficient period of time for the high-power mode 315 to put the power-consuming structure 210 into a desired condition.

For example, in some cases, it is desirable for the low-power mode 310 to be adopted a short time after a user leaves a power consuming structure 210 such as a home. In such cases, it may be advantageous for the exit boundary region 230 to correspond to a small area around the user's home (e.g., the irregular exit region 230 shown in FIG. 2, or, a circular area with a 100 yard radius). However, when returning to the power consuming structure 210, it may be desirable to adopt the high-power mode for a time that is long enough, e.g., to adjust the temperature of the home to comfortable conditions before the user arrives at the home. It such cases, the entry boundary region 225 can be advantageously defined to be large enough that an average commuting time from the perimeter of the entry boundary region 225 to the home is sufficient (e.g., a circular area with a 10 mile radius 227) for the high-power mode 315 to cause the home to have the desired condition.

One skilled in the art would understand how to obtain geolocations for mobile terminals 215 over a telecommunications network 220 in accordance with step 110. For instance, base station towers 217 of the telecommunications network 220 (e.g., a third or fourth generation of cellular wireless network) can be used to triangulate the mobile transmitter's location using radio communication to facilitate obtaining geolocations in the form of longitudinal and latitudinal coordinates or their equivalent. As a non-limiting example, U.S. Pat. No. 6,650,902, incorporated by reference herein in its entirety, provides an example of obtaining the geolocations of mobile terminals.

In some embodiments it is advantageous for the telecommunications network 220 to employ a base station network that comprises an extensive number of base stations 217 and a geolocation server 222, e.g., furnished by a utility company, such as a telephone company, because such a network 220 may allow greater accuracy in obtaining and determining geolocations (steps 110, 125) over a broad region of territory and using mobile terminals 215 of a simple design.

In other embodiments of the telecommunications network 220, however, the mobile terminals 215 can be configured as a handset network to obtain and determine their own geolocations. For instance, each mobile terminal 215 can be configured with software or hardware that facilitates obtaining geolocations based upon geographical cell locations, signal strengths, GPS coordinates or similar information, and then using this information to obtain and determine its own location in accordance with steps 110 and 125.

In some embodiments, obtaining the geolocation information in step 110 includes a step 115 of polling each of the mobile terminals 215 to transmit location information over the wireless telecommunication network 220. For instance, in some cases, a geolocation-server 222 can cause one or more base stations 217 to send a poling command to the mobile terminals 215 to transmit signals back to the geolocation-server 222 (e.g., via the base stations 217), from which geolocations can be determined in step 125.

In some embodiments, obtaining the geolocation information in step 110 includes a step 117 of each one of the mobile terminals 215 transmitting location information over the wireless telecommunication network 220 whenever one of the mobile terminals 215 changes from one defined geographic cell location to another cell location of the network 220. For instance, in some cases, as the mobile terminal 215 changes location and roams from one base station 217 to another, the new base station 217 relays this information to the geolocation-server 222, from which geolocations can be determined in step 125.

In some embodiments, obtaining the geolocation information in step 110 includes a step 120 of periodically transmitting location information over the wireless telecommunication network information from each of the mobile terminals after a defined period of time. For instance, in some cases, each mobile terminal 215 can be configured to briefly (e.g., in less than about 1 sec) transmit a signal to one or more base stations 217, which, in turn, relay this information to the geolocation-server 222, from which geolocations can be determined in step 125.

In some embodiments, determining whether or not a mobile terminal 215 is located inside or outside of the boundary region 205 in accordance with step 125 can include a step 135 of comparing each mobile terminal's 215 geolocation to a database 240 that stores geolocation markers 245 (e.g., latitude and longitude co-ordinates) that define the boundary region 205. In some cases, the determining step 125 can include a step 140 of calculating distances 250 between each of the geolocations of the mobile terminals 215 and a geolocation of the power-consuming structure 205. The determining step 125 can also include a step 145 of comparing the calculated distance 250 to a boundary radius 227, e.g., for a circularly-shaped boundary region 205. The power-consuming structure 210 can be changed to the low-power consumption mode 310 when each one of the calculated distances 240 is equal to or greater than the boundary radius 227. Or, the power-consuming structure 205 can be changed to the high-power consumption mode 315 when at least one of the calculated distances 240 is less than the boundary radius 227. Based upon the present disclosure, one of ordinary skill in the art would be able to ascertain other methods for performing the determining step 125.

In some embodiments, changing the power mode 305 in step 130 can include a step 150 of communicating a signal to a thermostat 255 controlling the power-consuming structure 210, or its components, such as a heating, ventilating, and air conditioning (HVAC) system 260, of the power-consuming structure 210, to initiate one of two set-points associated with one of the low-power consumption mode 310 or the high-power consumption mode 315, respectively. Initiating the change in set-point can cause at least one component of the HVAC system (e.g., a blowing, heating or cooling component) to deactivate or activate.

For instance, in the summer, when each of the mobile terminals 215 are outside of the boundary region 210, changing the power mode 305 (step 130) can include changing to a low-power consumption mode 310 (step 132) which can include communicating a signal (step 150) which causes the thermostat 255 to adopt a first set-point that is a high temperature set-point. The thermostat 255 can then, in step 155, send a control signal to the power consuming structure 210 (e.g., the HVAC system 260) such that the cooling component is deactivated, at least until the high temperature set-point is reached. Or, in the summer, when at least one of the mobile terminals 215 are inside the boundary region 210, changing to the high-power consumption mode 315 (step 134) includes communicating the signal (e.g., in step 150) that causes the thermostat 255 to adopt a second set-point that is a low-temperature set-point. The thermostat 255 can then send a control signal (e.g., in step 155) to the HVAC system 260 such that the cooling component of the HVAC system 260 is activated.

It can be advantageous for embodiments of the thermostat 255 to be configured to further include a time-based power temperature management program. For example, the thermostat 255 can include time-based high and low temperature set-point entries for the heating and cooling components of the HVAC system 260. In some cases, the two set-points associated with one of the low-power and high-power consumption modes 310, 315 can also be entries in the time-based power temperature management program. The time-based power temperature management program can be programmed to apply as a default under certain conditions. For instance, when all of the occupants have returned to the home, it can be desirable for a time-based low-power mode to be adopted overnight at an evening time set-point 320, or, for a time-based high-power mode to be adopted at a morning time set-point 325. Or, when all of the occupants are away from the home for an extended period (e.g., a vacation or a business trip) it can be desirable for a similar time-based power temperature management program to be applied, e.g., to avoid freezing indoor plumbing.

It can also be advantageous for embodiments of the thermostat 255 to be further configured to include a program that overrides the time-based high and low temperature set-point entries, based upon a change in the power mode 305 that can be initiated by geolocation information. Consider for example, as illustrated in FIG. 3, the case in the summer, when an occupant with their mobile terminal 215 leaves their home 210 earlier than normal and crosses outside of the boundary region 205. In this case, the thermostat 255 can be programmed to adopt a high-temperature set point, corresponding to the low-power mode 310, even though the morning time set-point 325 has not yet been reached. Similarly, the thermostat 255 can be programmed to delay adopting a low-temperature set point, corresponding to the high-power mode 315, if the occupant returns to their home 210 later than normal. As a consequence, the temperature 330 of the home 210 over the course of the day will remain elevated for a longer period, thereby resulting in reduced power consumption.

In some embodiments, changing the power mode 305 in step 130 can include a step 160 of communicating a signal to a power-management device 265 configured to regulate power used by the power-consuming structure 210. One skilled in the art would be familiar with such power-management devices 265 and how these devices 265 can be coupled directly or indirectly to a power-consuming structure 210. A non-limiting example of one such power-management device is the Power Save 1200 (PS 1200 from Plug and Save) for residential use. The power-management device 265 can be configured, in step 165, to send a control signal to the power consuming structure 210.

In some cases, the power-management device 265 can be programmed with defined set-points corresponding to the high-power and low-power consumption modes 310, 315. For instance, the power-management device 265 can be configured to run an air conditioning component of an HVAC system 260 at a reduced power set-point (e.g., one-half or one-quarter power or off) that is associated with the low-power consumption mode 310.

In some cases, the power-management device 265 performs power regulation of the power-consuming structure 210 in step 130 according to a smart-metering program, e.g., controlled or defined by a power utility provider 270 (via, e.g., a program defined on the utility provider's server 272).

For example, the signal communicated to the power-management device 265 in step 160 can be directly or indirectly provided from the power utility provider 270 that the user of the power-consuming structure 210 has contracted to receive power from. The power-management device 265 can thereby be configured to perform power regulation of the power-consuming structure 210 (step 165) according to a smart-metering program that is controlled or defined by the power utility provider 270. For instance, the smart-metering program can configure the power-management device 265 to adopt particular set-points associated with the high-power and low-power consumption modes 310, 315 defined in a power management protocol of the smart-metering program. For instance, the power management protocol could include the extent of decrease in delivered power when entering the low-power mode 310, as well as periods during the day or days of the week, when the low-power mode 310 is adopted.

In some cases, it is desirable for the smart-metering program, in step 170, to calculate a billing plan for the power-consuming structure 210 based the power regulation performed in step 130. For instance, when the power management protocol is adopted by the power-management device 265, the user of the power-consuming structure 210 may be billed at a less costly rate for the power consumed over a billing cycle, e.g., because the utility provider 270 has the option to reduce power delivered to the power-consuming structure 210 at times during the day when there are peak power demands from other consumers.

Another embodiment of the disclosure is a system 200 for controlling power consumption. The system can comprise any of the embodiments discussed above in the context of FIGS. 1-3.

For example, some embodiments of the system 200 can comprise means for: defining the boundary region 205 (step 105), obtaining the geolocations (step 110), determining whether or not the one or more mobile terminals 215 are inside or outside of the boundary region 205 (step 125), and change the power mode of the power-consuming structure 210 (step 130).

For example, some embodiments of the system 200 comprise a geolocation server 222. The geolocation server 222 can be configured to store a virtual representation of a boundary region 205 surrounding a power-consuming structure 210, receive geolocation information from one or more mobile terminals 215, and determine whether or not the one or more mobile terminals 215 are located inside or outside of the boundary region 205. For example, the system 200 can also comprise a power-adjusting device (e.g., a thermostat 255 or a power-management device 265) in communication with the geolocation server 222, and, configured to change a power mode 305 of the power-consuming structure 210. The power-consuming structure's 210 power mode 305 can be changed to a low-power consumption mode 310 when the geolocations of each of the mobile terminals 215 are outside of the boundary region 205. Or, the power-consuming structure's 210 power mode 305 can be changed to a high-power consumption mode 315 when the geolocation of at least one of the mobile terminals 215 is inside the boundary region 205.

In some embodiments of the system 200, the boundary region 205 includes an exit boundary region 230 and an entry boundary region 225. For example, in some embodiments, the means for changing the power-consuming structure 210 to the low-power consumption mode 310 (e.g., the power adjusting device) is configured to occur when each of the mobile terminals 215 have moved from inside to outside of the exit boundary region 230. For example, in some embodiments, the means for changing the power-consuming structure 210 to the high-power consumption mode 315 (e.g., the power adjusting device) is configured to occur when at least one of the mobile terminals 215 has moved from outside to inside of the entry boundary region 225.

In some embodiments of the system 200, the means for obtaining the geolocations includes a telecommunications network 220, e.g., comprising one or more base stations 217 in wireless communication with the one or more mobile terminals 215, and, in communication with a geolocation server 222. For example, the system 200 can further include a telecommunications network 220 configured to carry communications (e.g., of geolocation information) between the one or more mobile terminals 215 and the geolocation server 222.

Embodiments of the geolocation server 222 can be configured to determine the geolocations based upon location information communicated from the base stations 217. Embodiments of the geolocation server 222 can also be configured to determine whether or not the low-power consumption mode 310 or the high-power consumption mode 315 applies based upon the geolocations of the mobile terminals 215 relative to the boundary region 205 (or regions 225, 230). That is, if all the mobile terminals 215 are outside the boundary region 205, then the low-power mode 310 applies, but if one or more of the mobile terminals 215 are inside the boundary region 205, then the high-power mode 315 applies.

In some embodiments, the geolocation server 222 is configured to communicate with a utility provider's 270 server 272. The communication between the geolocation server 222 and the utility provider server 272 can include instructions from the utility provider server 272 to adopt a power management protocol defined by a utility provider. The communication can include instructions sent from the geolocation server 222 that includes changes in the power mode 305 of the power consuming structure 210.

For instance, the power management protocol could include temperature set-points corresponding to low- and high-power modes that are sent from the geolocation server 222 to a power-management server 275, and from there, sent on to a power-adjusting device such as a thermostat 255 coupled to the power consuming structure 210. Or, the power management protocol could include power set-points that are sent from the geolocation server 222 to the power-management server 275 and on to a power-adjusting device such as power-management device 265 coupled to the power-consuming structure 210. In some cases, the power management protocol could include information about changes in the temperature or power mode set-points at particular dates, times and durations as defined by an end-user or by a utility provider.

For instance, in some embodiments, the geolocation server 222 can be configured to communicate with a user-controlled device 280. In some cases, the user-controlled device 280 can be a computer located in the vicinity or inside of the power consuming structure 210. For instance, the geolocation server 222 can include a power management protocol downloadable from the geolocation server 222 to the user-controlled computer device 280. For instance, geolocation server 222 can also, or alternatively, include a user-defined power management protocol uploaded from the user-controlled device 280 to the geolocation server 222. The device 280 can be in communication with the geolocation server 222 via wired or wireless communication means 282 (e.g., a modem and internet connection provided by telephone or cable companies, satellite companies or other service providers). In some cases the user-controlled device 280 can be part of the thermostat 255 or power-management device 265. In other cases the user-controlled device 280 can be communication with the thermostat 255 or the power-management device 265 via a wired or wireless local-area network 285 (e.g., a home area network).

In some embodiments of the system 200 further includes a power management server 275. In some cases, the power management server 275 can be part of the means for changing the power-consuming structure 210. The power management server 275 can be configured to receive instructions from the geolocation server 222. The instructions can include commands to change to a different power mode 305. The power management server 275 can be configured to transmit the instructions to the power-consuming structure 210 in order to apply the different power mode 305 (e.g., from low to high power modes, or, from high to low power modes).

A person of ordinary skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform the steps of the above-described methods.

It should also be appreciated by those skilled in the art that any block diagrams, such as shown in FIGS. 2-3, herein can represent conceptual views of illustrative circuitry embodying the principles of the disclosure. Similarly, it will be appreciated that the flow diagram depicted in FIG. 1 can represent various processes which may be substantially represented in computer-readable medium and so executed by a computer or processor.

For instance, another embodiment of the disclosure is a computer-readable medium. The computer readable media can be embodied as any of the above-described computer storage tools. The computer-readable medium comprises computer-executable instructions that, when executed by a computer, perform method steps 105, 110, 125 and 130 as discussed above in the context of FIGS. 1-3. In some cases, the computer-readable medium comprises computer-executable instructions that also include other steps such as discussed in the context of FIG. 1. In some cases the computer-readable medium is a component of a system for controlling power consumption, such as embodiments of the system 200 discussed in the context of FIGS. 1-3. In some cases, for instance, the computer-readable medium can be memory or firmware in a geolocation server 222 of the system 200. In other cases, the computer-readable medium be a hard disks, CDs, floppy disks in the server 222 that is remotely located from the power consuming structure 210 but sends the computer-executable instructions to the structure 210.

Although the embodiments have been described in detail, those of ordinary skill in the art should understand that they could make various changes, substitutions and alterations herein without departing from the scope of the disclosure.

What is claimed is:

1. A method of controlling power consumption, comprising:
defining a boundary region surrounding a power-consuming structure;
obtaining geolocations for one or more mobile terminals over a telecommunications network;
determining whether or not said one or more mobile terminals are located inside or outside of said boundary region;
changing a power mode of said power-consuming structure to:
a low-power consumption mode when said geolocations of each of said mobile terminals are outside of said boundary region, or,
a high-power consumption mode when said geolocation of at least one of said mobile terminals is inside said boundary region.

2. The method of claim 1, wherein defining said boundary region includes defining an irregularly-shaped region.

3. The method of claim 1, wherein defining said boundary region includes defining an exit boundary region and defining an entry boundary region, and, wherein said power mode of said power-consuming structure is changed to said low-power consumption mode when each of said mobile terminals moves from inside said exit boundary region to outside of said exit boundary region, and, said power-consuming structure is changed to said high-power consumption mode when at least one of said mobile terminals move from outside of said entry boundary region to inside of said entry boundary region.

4. The method of claim 3, wherein said exit boundary region is smaller in area than said entry boundary region.

5. The method of claim 1, wherein obtaining said geolocation information includes polling each one of said mobile terminals to transmit location information over said wireless telecommunication network.

6. The method of claim 1, wherein obtaining said geolocation information includes each one of said mobile terminals transmitting location information over said wireless telecommunication network whenever one of said mobile terminals changes from one defined geographic cell location to another geographic cell location of said wireless telecommunication network.

7. The method of claim 1, wherein obtaining said geolocation information includes periodically transmitting location information over said wireless telecommunication network information from each of said mobile terminals after a defined period of time.

8. The method of claim 1, wherein said determining further includes:
calculating distances between each of said geolocations of said mobile terminals and a geolocation of said power-consuming structure; and
comparing said calculated distances to a boundary radius for a circularly-shaped boundary region, wherein:
said power-consuming structure is changed to said low-power consumption mode when each of said calculated distances are equal to or greater than said boundary radius, or
said power-consuming structure is changed to said high-power consumption mode when at least one of said calculated distances are less than said boundary radius.

9. The method of claim 1, wherein changing said power mode includes communicating a signal to a thermostat controlling a HVAC system of said power-consuming structure to initiate one of two set-points associated with one of said low-power consumption mode or said high-power consumption mode.

10. The method of claim 9, wherein said predefined set-points are also entries in a time-based power temperature management program of said thermostat.

11. The method of claim 1, wherein, changing said power mode includes communicating a signal to a power-management device configured to regulate power used by said power-consuming structure.

12. The method of claim 11, wherein said power-management device is programmed with predefined set-points associated with said high-power consumption mode and said low-power consumption mode.

13. The method of claim 11, wherein said power-management device performs power regulation of said power-consuming structure according to a smart-metering program controlled by a power utility provider.

14. The method of claim 13, wherein said smart-metering program calculates a billing plan for said power-consuming structure, based upon said power regulation.

15. A system for controlling power consumption, comprising:
a geolocation server, said geolocation server configured to:
store a virtual representation of a boundary region surrounding a power-consuming structure,
receive geolocation information from one or more mobile terminals, and
determine whether or not said one or more mobile terminals are located inside or outside of said boundary region;
a power-adjusting device in communication with said geolocation server, and, configured to change a power mode of said power-consuming structure to:
a low-power consumption mode when said geolocations of each of said mobile terminals are outside of said boundary region, or,
a high-power consumption mode when said geolocation of at least one of said mobile terminals is inside said boundary region.

16. The system of claim 15, wherein said boundary region includes an exit boundary region and an entry boundary region, and, wherein:
said power-adjusting device is configured to change said power-consuming structure to said low-power consumption mode when each of said mobile terminals have moved from inside said exit boundary region to outside of said exit boundary region, and
said power-adjusting device is configured to change said power-consuming structure to said high-power consumption mode when at least one of said mobile terminals has moved from outside of said entry boundary region to inside of said entry boundary region.

17. The system of claim 15, further including a telecommunications network configured to carry communications between said one or more mobile terminals and said geolocation server.

18. The system of claim 15, wherein said geolocation server is configured to communicate with a utility provider server, wherein communication between said geolocation server and said utility provider server includes:
instructions from said utility provider server to adopt a power management protocol defined by a utility provider, and
information sent from said geolocation server, said information including changes in said power mode of said power consuming structure.

19. The system of claim 15, wherein said geolocation server is configured to communicate with a user-controlled computer, said geolocation server including:
a power management protocol downloadable from said geolocation server to said user-controlled computer, or
a user-defined power management protocol uploaded from said user-controlled computer to said geolocation server.

20. A computer-readable medium, comprising:
computer-executable instructions that, when executed by a computer, perform the method steps of claim 1.
